(19) United States
(12) Patent Application Publication
(10) Pub. No.: US 2009/0315424 A1
(43) Pub. Date: Dec. 24, 2009

(54) PERMANENT MAGNET SYNCHRONOUS MACHINE WITH SHELL MAGNETS

(75) Inventor: ROLF VOLLMER, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/335,986

(22) Filed: Dec. 16, 2008

(30) Foreign Application Priority Data
Dec. 17, 2007 (EP) 07024405

(51) Int. Cl. H02K 1/27

(52) U.S. Cl. 310/156.43

(57) ABSTRACT

A permanent-magnet synchronous machine includes a stator that has slots and a rotor that has permanent magnets which form magnet poles. The permanent magnets are shell magnets having two curved surfaces. Each shell magnet covers a predetermined part of a magnet pole. The external radius of the shell magnets is less than 0.6 times the radius of the stator bore. Each shell magnet has a quasi-radial magnetic preferred direction that is directed substantially perpendicular to its outer surface.

### CROSS-REFERENCES TO RELATED APPLICATIONS

This application claims the priority of European Patent Application, Serial No. 07024405, filed Dec. 17, 2007, pursuant to 35 U.S.C. 119(a)-(d), the content of which is incorporated herein by reference in its entirety as if fully set forth herein.

### BACKGROUND OF THE INVENTION

The present invention relates, in general, to a permanent-magnet synchronous machine.

Nothing in the following discussion of the state of the art is to be construed as an admission of prior art.

Permanent-magnet synchronous machines often exhibit torque ripple during operation, which generally results in undesirable harmonics from the interaction between the slot system and the pole formation, which harmonics occur as cogging torques (reluctance moments) and result in harmonics in the induced voltage caused by the excitation field.

Various structural suppression means for reducing this phenomenon in dynamo-electric machines are known. For example, German Offenlegungsschrift DE 100 41 329 A1 describes permanent magnets providing a 70 to 80% pole coverage on the surface area of the rotor.

German Offenlegungsschrift DE 199 61 760 A1 discloses that special winding features of a winding system disposed in the slots and an inclination of the slots leads to an improved harmonic suppression.

German Offenlegungsschrift DE 10 2004 045 939 A1 discloses a permanent-magnet synchronous machine that has a plurality of suppression means. In this case, not only is the permanent magnet formed with only one partial pole coverage but it is proposed that the permanent magnets of a pole also be staggered, or that the slots be inclined. Furthermore, as a further suppression means, additional staggering of the permanent magnets of a magnetic pole or a second inclination of the permanent magnets, or a second inclination of the slots, is proposed.

A drawback associated to all these approaches is the increased complexity of assembly and the accompanying increased manufacturing costs of the permanent-magnet synchronous machines.

It would therefore be desirable and advantageous to provide an improved permanent-magnet synchronous machine to overcome the prior art shortcomings and to reduce harmonics in the air-gap magnetic field, suppress torque ripple, and reduce eddy-current and hysteresis losses in the iron of the stator of the permanent-magnet synchronous machine.

### SUMMARY OF THE INVENTION

According to one aspect of the present invention, a permanent-magnet synchronous machine includes a stator having slots, and a rotor having permanent magnets which form magnetic poles, the poles having edges, the permanent magnets being constructed in the form of shell magnets having two curved surfaces, each shell magnet covering a given part of a magnet pole and having a quasi-radial magnetic preferred direction that is substantially perpendicular to an outer surface of the permanent magnet.

According to another feature of the present invention, an external radius of each shell magnet may be less than 0.6 times a radius of the stator bore.

According to another feature of the present invention, the quasi-radial alignment in the magnetic preferred direction may be governed by the relationship α_{div}=0.3 . . . 0.9 α_{geom} wherein α_{div} is an outlet angle of the quasi-radial field lines from the outer surface of the shell magnet, and α_{geom}=is an angle of the partial pole coverage of the magnetic pole.

According to another feature of the present invention, wherein the magnetic poles and the stator define an air gap there between which may increase in a direction of the pole edges, while a thickness of the shell magnet may decrease in the direction of the pole edges.

The proposed measures significantly reduce the torque ripple of a permanently-excited (permanent-magnet) synchronous machine.

Multiple factors are responsible for the formation of the disturbing torque ripple, including reluctance forces that cause cogging between wound teeth and permanent magnets having a cogging number of pole pairs. A further main cause of torque ripple is the interaction between the rotor and stator magnetic force fields in the air gap of the dynamo-electrical machine. It should be noted that the fifth and the seventh harmonics of the fundamental frequency of the magnetic field formed in the air gap are particularly disturbing.

The fundamental wave is the component of the air-gap field that governs torque formation. In addition to deforming the desired sinusoidal air-gap magnetic field, these harmonics also cause the formation of parasitic torques that may even counteract the actual torque.

By addressing these causes of torque ripple, measures implemented in accordance with the present invention each further reduce torque ripple without having to additionally modify the stator and/or the rotor by inclining the slots and/or the permanent magnets or by staggering them.

In particular, considerable reduction in the torque ripple is achieved by the quasi-radial magnetic preferred direction of the permanent magnets, either surface magnets or buried magnets, which directed substantially at right angles to the outer surface, particularly in conjunction with the geometric form of the shell magnets with respect to the stator bore. This also leads to a reduction in the eddy-current and hysteresis losses in the iron of the stator.

The radial, or at least quasi-radial, magnetic preferred direction of the permanent magnets is evident in particular in the magnetic profile of the field lines of the permanent magnets in the air gap of the dynamo-electrical machine. The field lines do not run parallel but run apart from one another, that is to say they diverge.

In a further refinement, the internal radius of the shell magnets is additionally equal to the external radius. This leads to a further reduction in the harmonics of the magnetic air-gap field of the permanent-magnet synchronous machine and thus in the torque ripple, since this results in an air gap which increases from the pole center to the pole edges, as a result of which fewer field lines of the permanent magnets pass through the tooth of the stator, in particular the tooth head and therefore in the end the iron. The iron and hysteresis losses in the permanent-magnet synchronous machine are therefore reduced, particularly at high rotation speeds. In particular, this results in an air gap that increases from the center of each permanent magnet to the edges of the respective permanent magnet. The profile is continuous, that is to say there are no sudden changes on the surface of the permanent magnet that faces the air gap of the dynamo-electrical machine.

In a further refinement, the angle of the partial pole coverage area of the permanent magnets α_{geom}, of the shell magnet in the area of the respective magnetic pole in particular, can be chosen to be in the range between 0.9 times ατₚ and 0.5 times ατₚ, that is to say between 0.9 and 0.5 times that of one magnetic pole, as illustrated in FIG. 3.

The measures according to the invention are extremely advantageous since the shell magnets on the rotor can just be consecutively axially arranged without having to provide any inclination. Experience teaches that implementation of such inclination would have to be carried out exactly, with very precise positioning, in order not to exacerbate other parasitic effects such as the harmonics of the air-gap field and thus to result in increased torque ripple.

In principle, a magnetic pole of the rotor has at least one shell magnet. However, it is quite possible to arrange a plurality of shell magnets axially one behind the other in order, for example, to fit the axial length of a rotor with shell magnets of the same polarization. In addition or separately, it is also feasible to form the shell magnets of a magnetic pole from a plurality of partial shell magnets in the circumferential direction, such that the partial shell magnets together have a partial pole coverage factor of the pitch noted above. In particular, such partial shell magnets can be fitted together with virtually no gap between their poles.

The partial shell magnets of a magnetic pole are not identical, because the outer and inner surfaces of the entire shell magnet have the same radius. They therefore differ with respect to their radial thickness, in particular.

### BRIEF DESCRIPTION OF THE DRAWINGS

Other features and advantages of the present invention will be more readily apparent upon reading the following description of currently preferred exemplified embodiments of the invention with reference to the accompanying drawing, in which:

FIG. 1 is a cross section through a permanent-magnet synchronous machine,

FIG. 2 is an enlarged detailed view of the area encircled in FIG. 1 and marked II,

FIG. 3 is a schematic illustration of a magnetic pole with a shell magnet,

FIG. 4 is a geometric configuration of a shell magnet.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

The invention is also applicable to combination drives in which a rotating electric motor and a cylindrical linear motor jointly drive a shaft and move axially. Such a combination drive is described, for example, in German Offenlegungsschrift DE 10 2004 056 212 A1. The content of that German laid-open application is included herein by reference.

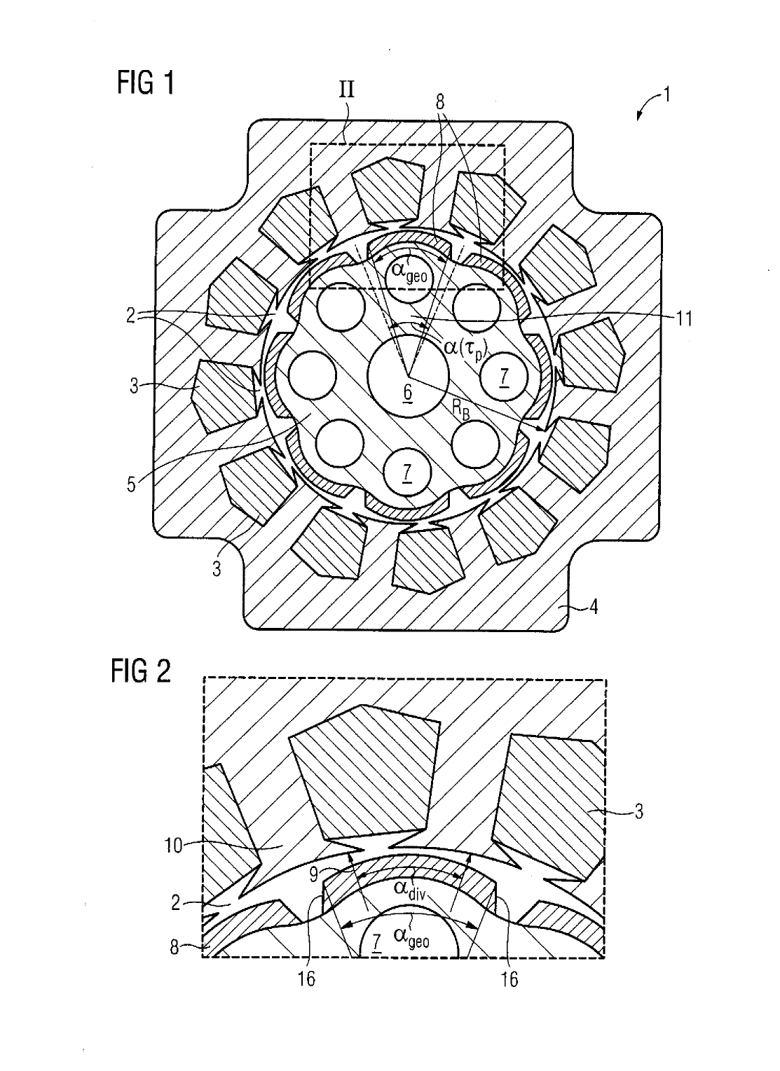

Turning now to the drawings, FIG. 1 is shown a cross sectional view of a permanent-magnet synchronous machine 1 having a stator 4 and a rotor 5 arranged in the stator bore.

In its slots 2, the stator 4 has a winding system 3 which could be a conventional fractional-pitch winding, but also could be a tooth-wound coil winding. In the tooth-wound coil winding, each tooth-wound coil surrounds one tooth on the stator 4. The tooth-wound coil is formed from round wires, flat wires or braided wires. Each tooth-wound coil has, in addition to its electrical connection, two coil sides which are positioned in slots surrounding a tooth, and end winding sections which connect the two coil sides. The tooth-wound coils are either wound onto a coil former or are wound with the aid of a template from which they are then removed before fitting. The entire content of DE 199 61 339 A1, particularly its disclosure regarding tooth-wound coils, is included herein by reference.

Preferably the following two types of tooth-wound coils are used. In the first type, only one coil side of a tooth-wound coil is located in any one slot 2 of the stator 4, as a result of which only every alternate tooth has a tooth-wound coil surrounding it. In the second type, two coil sides of different tooth-wound coils of adjacent teeth are located in one slot 2. Each tooth is therefore surrounded by a tooth-wound coil in the second type of tooth-wound coil winding.

The slots 2 shown in FIG. 1 are in the form of half-closed slots 2. In principle, the stator 4 may also be formed with open slots. In the case of half-closed slots 2, the windings are advantageously threaded into the stator bore. This winding process can be simplified if the slots are open or if the stator is split in two with the slots 2 virtually closed or if the dynamo-electrical machine has a small axis height, that is to say the winding is positioned from the outside on or around the teeth in order to then insert this pack axially into the rear of a yoke, in order to provide a magnetic return path. The entire content DE 196 52 795 A1, particularly its disclosure regarding a stator that is split in two, is included herein by reference.

In a further embodiment of open or half-closed slots 2, slot sealing wedges which are not further illustrated in FIG. 1 can be provided that have predetermined magnetic characteristics.

The rotor 5 is connected to a shaft 6 such that they rotate together and has permanent magnets 8 that are shell magnets on its outer surfaces which, in particular, have a rippled shape. These shell magnets have essentially two surfaces, in addition to their edge-boundary surfaces, which are referred to as the outer surface 14 and the inner surface 15, the inner surface 15 being matched to the rippled shape of the rotor 5. However, it is the outer surface 14 that faces the air gap of the permanent-magnet synchronous machine 1.

Radially internal to the rippled surfaces, the rotor 5 itself has actual openings 7 which contribute to cooling of the rotor 5 on the one hand and, on the other hand, to the low inertia of the rotor 5 that further improves the dynamics of the drive.

The rotor 5 may likewise be formed without a rippled structure, that is to say, when viewed in the form of a cross section, it is round. However, positioning and fixing must then be provided for the shell magnets.

FIG. 2 shows a detail view of the configuration and in particular the magnetic preferred direction 9 of the shell magnets. This preferred direction is designed to be radial, or at least quasi-radial with respect to the outer surface 14 of the shell magnets, in particular, thus resulting in the torque ripple being suppressed. The angle of the field lines is preferably α_{div}=0.3 . . . 0.9 α_{geom}.

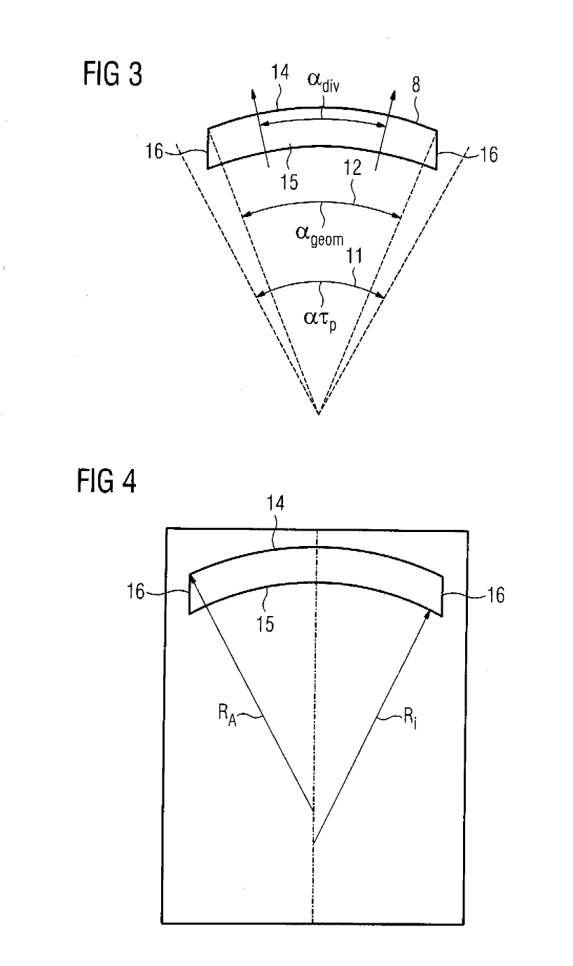

Magnets with a curved surface are normally magnetized parallel, that is to say, the field lines run parallel outside the permanent magnets, and do not have a radial magnetic anisotropy, in particular a quasi-radial magnetic anisotropy, unlike shell magnets according to the invention. FIG. 3 shows a schematic illustration of the of the configuration of a magnetic pole 11 of the rotor 5 having a permanent magnet 8 which is in the form of a shell magnet and provides a partial pole coverage 12. The partial pole coverage is

$$\frac{{α}_{geom }}{α {τ}_{p}}$$

where

$$α {τ}_{p} = \frac{{360}^{∘}}{29} ;$$

wherein 2p is the number of magnetic poles 11.

In the case of a rotating dynamo-electrical machine, the rotor is circumferentially subdivided, depending on the number of poles, into angle sections ατₚ that each correspond to one magnetic pole 11. In the case of a rotating dynamo-electrical machine, the magnetic pole 11 therefore has an angle of ατₚ. The partial pole coverage 12 is selected from the predetermined range of 0.9-times the magnetic pole angle ατₚ to 0.5-times the magnetic pole angle ατₚ, depending on the desired reduction factors for respective harmonics. The partial pole coverage angles α_{geom} of the shell magnets of a magnetic pole ατₚ are therefore between 0.9ατₚ>α_{geom}>0.5ατₚ. This results in a further reduction in the torque ripple.

The side surfaces 16 of the shell magnets shown in the figures are either radially aligned or beveled so that the shell magnet extends in the direction of the edge regions of the magnetic pole 11.

In a rotary permanent-magnet synchronous motor the magnetically critically important area, particularly the angular area α_{geom} shown in FIG. 3, is more relevant for partial pole coverage than the outer edges of the respective permanent magnet 8. Since virtually no field lines of the permanent magnetic 8 emerge on the side surfaces 16, even when the side surfaces 16 of the permanent magnet 8 are beveled the partial pole coverage factor does not change. The critical factor is therefore the value of the partial pole coverage angle 12, α_{geom}, that is to say the angular range within which the magnetic field lines of the permanent magnets 8, which are shell magnets, emerge. This is therefore the surface 14 of the shell magnet, without the side surfaces 16.

FIG. 4 shows a configuration of the shell magnet, in which the external radius R_{A} of the shell magnet and the internal radius Rᵢ of the shell magnet are identical. This results in the shell magnet having a thickness that decreases slightly in the direction of the pole edges.

If the shell magnet is arranged within its magnetic pole 11, the thickness of the shell magnet, that is to say its radial extent, decreases in the direction of the pole edges. The air gap in the permanent-magnet synchronous machine is additionally increased in the direction of the pole edges, according to the invention, as a result of the ratio of the radius of the stator bore R_{B} to the radius of the shell magnet R_{A}, wherein R_{A}<0.6R_{B}.

Improved reduction of torque ripple is achieved by implementation of the individual measures, or a freely variable combination of these individual measures. That is to say, if the two radiuses of each shell magnet R_{A} and R_{I} are identical, or if the ratio of R_{A} to R_{B} is less than 0.6, or if shell magnets having quasi-radial anisotropy, preferably α_{div}=0.3 . . . 0.9 α_{geom} are used, or a predetermined partial pole coverage ratio of 0.9 to 0.5 is used, both torque ripple and losses in the stator 4 such as iron losses and hysteresis losses are reduced by these measures, particularly during high-speed rotation at speeds greater than 5000 rpm.

This means that the individual features themselves lead to a reduction in the level of the harmonics and of partial combinations. In particular the overall combination of the features described above creates a virtually sinusoidal profile of magnetic flux density in the air gap.

In particular, with each shell magnet providing a predetermined partial pole coverage having a radial (quasi-radial to be precise) magnetic anisotropy in this preferred direction, the interaction of a combination of the partial pole coverage provided by each shell magnet having an identical radius on the inner surface 15 and the outer surface 14 of each shell magnet, that is to say the outer surface of the shell magnet facing the air gap of the dynamo-electrical machine, with a ratio of the external radius R_{A} of the outer surface of the shell magnets to the stator bore R_{B} that is less than 0.6 and, in particular preferably α_{div}=0.3 . . . 0.9 α_{geom}, results in an extremely effective reduction in the torque ripple in accordance with the invention.

A low level of torque ripple is achieved by a sinusoidal air gap field in the air gap of the permanent-magnet synchronous machine. As a result, the profile of the flux density that is formed in the air gap is sinusoidal.

In previously-used permanent magnets with parallel anisotropy, the field lines of the permanent magnet run parallel and/or the radius of the outer and inner surfaces is different, as in the prior art, thus resulting in a constant air gap at least in the area of the permanent magnet. The flux density in the area of the permanent magnet therefore has a virtually constant profile. The gradient of the zero crossing of this flux-density profile over the magnetic poles at the pole edges is relatively low. This results in there being virtually no scatter, because all field lines of the permanent magnet cross over into the iron of the stator.

In accordance with the invention, because a radial or at least quasi-radial anisotropy is used, as described above, it is accepted that the scatter will be comparatively greater since there are no longer as many field lines crossing over into the iron of the stator. The flux density profile therefore approximates a sinusoidal profile.

Through combining radial dimensions, that is to say R_{A} less than 0.6 times R_{B}, and R_{A} equal to R_{I}, if needed, with the characteristic of one of the partial pole coverage factors determined by pitch in accordance with the invention, the resulting flux-density is virtually sinusoidal. That is to say, although the scatter is admittedly comparatively high since fewer field lines of the permanent magnet 8 pass through the iron of the stator 4 in the region of a pole element; on the other hand, the parasitic harmonics are almost completely compensated.

This admittedly also reduces the power output of the drive, but the torque ripple is considerably reduced. The iron and hysteresis losses in the stator 4 therefore also decrease, particularly at high rotation speeds.

These dynamo-electrical machines are, in particular, suited for use in machine tools in which torque ripple, in particular, must be avoided to ensure that the machined work piece surfaces have good machining quality.

Although the invention has been illustrated and described in connection with currently preferred embodiments that are shown and described in detail, it is not intended to be limited to the details thus shown, since various modifications and structural changes may be made without departing in any way from the spirit of the present invention. Embodiments were selected and described herein to and best explain the invention and its practical application, so as to enable a person skilled in the art to best utilize embodiments of the invention with various modifications suited to the particular use contemplated.

What is claimed as new and desired to be protected by Letters Patent is set forth in the appended claims and includes equivalents of the elements recited therein:

What is claimed is:

1. A permanent-magnet synchronous machine, comprising:
a stator having slots; and
a rotor having permanent magnets which form magnetic poles, said poles having edges, said permanent magnets being constructed in the form of shell magnets having two curved surfaces, each shell magnet covering a given part of a magnet pole and having a quasi-radial magnetic preferred direction that is substantially perpendicular to an outer surface of the permanent magnet.

2. The permanent-magnet synchronous machine of claim 1, wherein an external radius of each said shell magnet is less than 0.6 times a radius of the stator bore.

3. The permanent-magnet synchronous machine of claim 1, wherein the quasi-radial alignment in the magnetic preferred direction is governed by the relationship α_{div}=03 . . . 0.9 α_{geom} wherein α_{div} is an outlet angle of the quasi-radial field lines from the outer surface of the shell magnet, and α_{geom}=is an angle of the partial pole coverage of the magnetic pole.

4. The permanent-magnet synchronous machine of claim 1, wherein the magnetic poles and the stator define an air gap there between which increases in a direction of the pole edges, while a thickness of the shell magnet decreases in the direction of the pole edges.

5. The permanent-magnet synchronous machine of claim 1, wherein the internal radius of the shell magnets is equal to the external radius of the shell magnets.

6. The permanent-magnet synchronous machine of claim 1, wherein the partial pole coverage of the shell magnets in the area of the magnetic pole is in the range between 0.9ατₚ>α_{geom}>0.5ατₚ, where ατₚ is the magnetic pole pitch of the rotor.

7. The permanent-magnet synchronous machine of claim 1, wherein the shell magnets of the magnetic poles of the rotor have the same partial pole coverage.

8. The permanent-magnet synchronous machine of claim 1, wherein the shell magnets of a magnetic pole are arranged axially one behind the other without any inclination.

9. The permanent-magnet synchronous machine of claim 1, wherein the shell magnets of a magnetic pole are formed in the circumferential direction within the magnetic pole from partial shell magnets.

10. The permanent-magnet synchronous machine of claim 1, wherein the magnetic poles of the rotor each have only one shell magnet.
